(19) United States
(12) Patent Application Publication
(10) Pub. No.: US 2025/0033246 A1
(43) Pub. Date: Jan. 30, 2025

(54) INTELLIGENT MONITORING SYSTEM AND METHOD FOR WIRE NET WAFERING

(71) Applicant: TCL ZHONGHUAN RENEWABLE ENERGY TECHNOLOGY CO., LTD., Tianjin (CN)

(72) Inventors: Haiming ZHANG, Tianjin (CN); Haoming ZHANG, Tianjin (CN); Xuzhou YANG, Tianjin (CN); Rui WU, Tianjin (CN); Chen WEI, Tianjin (CN); Pengzhan ZHAO, Tianjin (CN)

(73) Assignee: TCL ZHONGHUAN RENEWABLE ENERGY TECHNOLOGY CO., LTD., Tianjin (CN)

(21) Appl. No.: 18/548,878

(22) PCT Filed: Jul. 31, 2023
(86) PCT No.: PCT/CN2023/110412

§ 371 Date: Sep. 1, 2023

(30) Foreign Application Priority Data
Aug. 31, 2022 (CN) 202211061894.6

(51) Int. Cl. B28D 5/00; B28D 5/04; G01S 13/88

(52) U.S. Cl. CPC B28D 5/0064; B28D 5/045; G01S 13/88

(57) ABSTRACT

The present disclosure provides an intelligent monitoring system and method for wire net wafering. The system includes a monitoring unit, equipped with a monitor for capturing position data of cutting wires in a wire net; and a control unit, provided with a controller for receiving the data captured by the monitor, processing the data and notifying a wafering machine based on results of the processing to perform optimization and adjustment. This can solve the technical problem of being unable to monitor the status of a wire net in real time during a wafering process in the existing arts, automatically monitor the status of curvature of the wire net, judge whether the status of the wire net is abnormal, and effectively notify the wafering machine in time, if a problem is encountered, to perform parameter adjustment or transfer to manual intervention.

### CROSS-REFERENCE TO RELATED APPLICATION

The present disclosure claims priority to China Patent Application 202211061894.6, filed on Aug. 31, 2022, which is incorporated herein by reference in its entirety.

### TECHNICAL FIELD

The present disclosure relates to wafer processing, and more particularly to an intelligent monitoring system and method for wire net wafering.

### BACKGROUND

Multi-wire wafering machine is the core equipment in monocrystalline silicon or polycrystalline silicon processing. Monocrystalline silicon or polycrystalline silicon is cut into multiple thin slices by using the multi-wire wafering machine. During multi-wire wafering or slicing, a wire net made up by gold cutting wires cuts the silicon material once to obtain the multiple thin slices. However, during the cutting process, the wire net endures pressure from the silicon material after tightened due to the vibration of the wafering machine, the friction between the gold cutting wires and the silicon material, and etc., and this makes the cutting wires to be curved. Once the curvature of wires is too large or the wires have inconsistent curvature, if not tackled in time, it is very easy to cause the gold cutting wires to merge or jump. If the merge and jump problems become far worse, it will directly lead to wire breakage. If there has a broken wire, the wafering machine will be directly shut down. This will cause an increase in defective products, low utilization rate resulting from equipment downtime, and low production efficiency, not applicable to mass production.

At present, most wire net monitoring is carried out manually by observing the wire net in use via an observation window of the equipment. The gold cutting wires are monitored with experience, the naked eyes are used to observe and judge abnormal conditions such as jump, merge and breakage occurred on the cutting wires, and it is also impossible to accurately determine whether a silicon ingot has been cut across when the cutting of the silicon ingot is almost done. In addition, during the wafering, it is dark and has heavy mist in a slicing chamber. This will cause serious visual interference to the observers, and monitoring by vision is unable to be effectively achieved. In the production process, a shutdown is not always needed for all abnormalities of the wire net.

The existing manual operation for the monitoring not only cannot identify abnormal conditions regarding the consistency of the curvature of the wires and the status of the wire net, but also has a high false rate, low judgment efficiency and high production cost. Also, each time it needs manual intervention, and the efficiency on tackling abnormal conditions is low. The technical problems of defective products, equipment downtime and overhigh production cost, caused when the state of the wire net is abnormal, cannot be effectively solved.

### SUMMARY

The present disclosure provides an intelligent monitoring system and method for wire net wafering, for solving the technical problem of being unable to monitor the status of a wire net in real time during a wafering process in the existing arts.

To solve at least one of above problems, the technical solutions provided in the present disclosure are described below.

An intelligent monitoring system for wire net wafering includes: a monitoring unit, equipped with a monitor for capturing position data of cutting wires in a wire net; and a control unit, provided with a controller for receiving the data captured by the monitor, processing the data and notifying a wafering machine based on results of the processing to perform optimization and adjustment.

Further, an aperture of the monitor is arranged in a same direction as a rotation direction of the wire net; the monitor moves from a first position to a second position along a lengthwise direction of the wire net, and continuously transmits signals toward the cutting wires and captures returned signals to identify the position of the cutting wires; the captured signals are converted into digital signals, which are then transmitted to the controller.

Further, the controller is placed at each of two sides of a workpiece, and the controllers placed at both sides of the workpiece are disposed opposite to each other; when the controllers placed at both sides of the workpiece are switched alternately between a first rotation direction and a second rotation direction of the wire net, the controllers perform the monitoring of the wire net in the first rotation direction and the wire net in the second rotation direction alternately.

Further, the monitoring unit further includes: a housing, for protecting the monitor; and a position adjusting rod, connecting to the housing for adjusting a direction of the housing such that the monitor is tilted to transmit signals toward a face of the wire net in contact with the workpiece.

Further, the system further includes a cleaning unit, provided at a position directly facing the monitoring unit, wherein the cleaning unit includes a cleaning member and an enclosing unit that is placed around the cleaning member, and the enclosing unit is provided with an accommodation area for accommodating an end surface corresponding to the aperture of the monitor in the housing; wherein the cleaning member cleans in the accommodation area to clean the housing when the monitor moves to the first position.

Further, the system further includes a power unit, which includes a long track and a connecting block arranged along a lengthwise direction of the wire net, wherein the monitoring unit is connected to the connecting block, and the connecting block drives the monitoring unit to move on the long track.

Further, the system further includes a display unit, provided with a display, wherein the controller displays the results of the processing on the display in a form of curves.

An intelligent monitoring method for wire net wafering, based on any one of the afore-described system embodiments, includes the steps of:
controlling a monitor to capture position data of cutting wires in a wire net;
receiving the data captured by the monitor, processing the data and notifying a wafering machine based on results of the processing to perform optimization and adjustment.

Further, the controlling the monitor to capture the position data of the cutting wires in the wire net includes:
controlling an aperture of the monitor to be arranged in a same direction as a rotation direction of the wire net;
controlling the monitor to move from a first position to a second position along a lengthwise direction of the wire net, and continuously transmit signals toward the cutting wires and capture returned signals to identify the position of the cutting wires;
the captured signals are converted into digital signals, which are then transmitted to the controller.

Further, the receiving the data captured by the monitor, processing the data and notifying the wafering machine based on results of the processing to perform optimization and adjustment includes:
denoising, by the controller, the converted digital signals by using moving average, Gaussian algorithm and median filtering, to obtain height position of each cutting wire in each area of the wire net, and based on the obtained height position of each cutting wire in each area and the height position of a contact surface of a workpiece and the wire net in an area, obtaining a vertical distance between each cutting wire in the area and the contact surface of the workpiece and the wire net in the area, which is a curvature value and a jump value corresponding to each cutting wire in the area;
based on the curvature values and the jump values of all the cutting wires in each area during a cutting process, forming an independent curvature curve and jump curve corresponding to each area;
based on the curvature value of each cutting wire in each area obtained when an amount of cutting steps reaches a preset threshold, forming an overall curvature curve of all areas;
based on the independent curvature curve and jump curve corresponding to each area as well as the overall curvature curve of all areas, identifying which area is abnormal, and performing a parameter adjustment.

The intelligent monitoring system and method for wire net wafering, designed in accordance with the present disclosure, can automatically monitor the status of curvature of the wire net, automatically judge whether the status of the wire net is abnormal, minimize manual intervention, automatically process based on the judgment, and effectively notify the wafering machine in time, if a problem is encountered, to perform parameter adjustment or transfer to manual intervention.

### BRIEF DESCRIPTION OF THE DRAWINGS

FIG. 1 is a structural schematic diagram illustrating an intelligent monitoring system for wire net wafering according to an embodiment of the present disclosure.

FIG. 2 is a flowchart of data processing according to an embodiment of the present disclosure.

FIG. 3 is a diagram illustrating the position of monitors with respect to a workpiece according to an embodiment of the present disclosure.

FIG. 4 is a perspective view of a monitoring unit according to an embodiment of the present disclosure.

FIG. 5 is a perspective view of a cleaning unit according to an embodiment of the present disclosure.

FIG. 6 is a cross-sectional view of a cleaning member according to an embodiment of the present disclosure.

FIG. 7 is a perspective view of a power unit according to an embodiment of the present disclosure.

FIG. 8 is a diagram illustrating a distribution of areas for a wire net monitored by a monitor according to an embodiment of the present disclosure.

FIG. 9 is a diagram illustrating curve charts of curvature values in some areas according to an embodiment of the present disclosure.

FIG. 10 is a diagram illustrating a curve chart with a jump abnormality according to an embodiment of the present disclosure.

FIG. 11 is a diagram illustrating a curve chart with a merge abnormality according to an embodiment of the present disclosure.

FIG. 12 is a diagram illustrating a curve chart for a workpiece not being cut across according to an embodiment of the present disclosure.

In the drawings:

| | | |
|---|---|---|
| 10: workpiece; | 20: wire net; | 30: monitoring unit; |
| 31: monitor; | 32: housing; | 33: position adjusting rod; |
| 40: cleaning unit; | 41: cleaning member; | 42: enclosing unit; |
| 421: stand panel; | 422: folded panel; | 423: collecting panel; |
| 50: power unit; | 51: long track; | 52: connecting block; |
| 60: controller; | 70: display. | |

### DETAILED DESCRIPTION

The present disclosure will be described in detail below in conjunction with the drawings and embodiments.

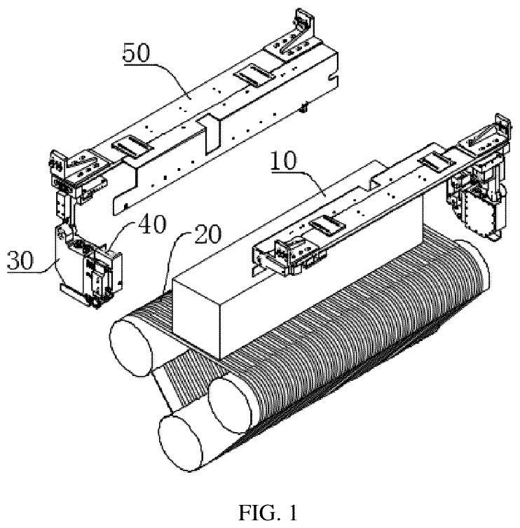

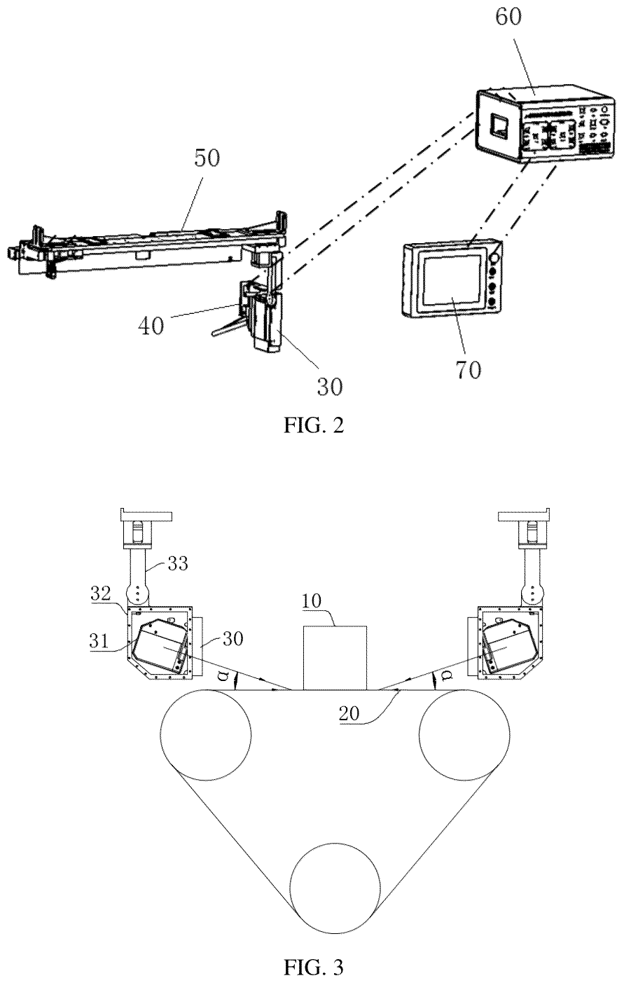

This embodiment proposes an intelligent monitoring system for wire net wafering. As shown in FIGS. 1 and 2, the system includes a monitoring unit 30 for monitoring a wire net 20 used when a workpiece 10 is cut, a cleaning unit 40 for cleaning a housing 32 of the monitoring unit 30, and a power unit 50 for controlling a movement of the monitoring unit 30, and also includes a control unit communicatively connected with the monitoring unit 30 and a display unit communicatively connected with the control unit. The monitoring unit 30 is equipped with a monitor 31 for capturing position data of cutting wires in different areas of the wire net 20. The control unit is provided with a controller 60 for receiving the data captured by the monitor 31, processing the data and notifying a wafering machine based on results of the processing to perform optimization and adjustment. The display unit is provided with a display 70. The controller 60 displays the results of the processing on the display 70 in a form of curves. A worker can judge a condition of the wire net 20 based on a trend of the curves on the display 70. The controller 60 can determine a status of the wire net 20 based on the results of the processing so as to adjust cutting parameters of the wafering machine in real time or notify a personnel for manual intervention operations without a need for the personnel to observe and monitor the status of the wire net 20.

Specifically, there is at least one set of monitoring units 30, and an aperture of the monitor 31 is arranged in a same direction as a rotation direction of the wire net 20. The wire net 20 cuts the workpiece 10 reciprocally in two rotation directions during the wafering, that is, positive rotation when feeding the wires and negative rotation when withdrawing the wires. In this application, the positive rotation when feeding the wires of the wire net 20 is set as a first rotation direction, and the negative rotation when withdrawing the wires of the wire net 20 is set as a second rotation direction. Since the rotation direction of the wire net 20 directly affects the direction the cutting fluid splashes, the monitor 31 should not detect along a direction against the rotation direction of the wire net 20 when monitoring the status of the wire net 20. In order to clearly and persistently monitor the rotating wire net 20, the aperture of the monitor 31 has to be arranged in a same direction as the rotation direction of the wire net 20. In such a way, it can prevent the cutting fluid from splashing to the aperture of the monitor 31 along the rotation direction of the wire net 20 to affect the monitoring.

In addition, during the cutting process, it is dark in a slicing chamber, the wire net 20 rotates steadily, and the cutting fluid persistently splashes toward a side of the wire net 20, resulting in heavy mist in the slicing chamber. It is not beneficial to observation with naked eyes or photographing. It is even more unfavorable for an external monitoring device to monitor the status of the wire net 20. In this application, a power unit 50 is especially provided along a lengthwise direction of the wire net 20. The power unit 50 can drive the monitoring unit 30 to detect at each position of the wire net 20 persistently along the lengthwise direction of the workpiece 10 to monitor the status of the wire net 20. In order to be able to monitor the status of the wire net 20 when the wires are fed along with the positive rotation and are withdrawn along with the negative rotation, a set of monitoring units 30 and power units 50 are separately arranged at both sides of the workpiece 10, and the monitoring units 30 are disposed opposite to each other with respect to the workpiece 10, as shown in FIG. 3. When the controllers 31 placed at both sides of the workpiece 10 are switched alternately between the first rotation direction and the second rotation direction of the wire net 20, the controllers 31 perform the monitoring of the wire net 20 in the first rotation direction and the wire net 20 in the second rotation direction alternately.

That is, when the wafering is performed along with the first rotation direction of the wire net 20, this rotation direction is a forward rotation for the monitoring unit 30 on the left side, and is a backward rotation for the monitoring unit 30 on the right side. Meanwhile, the monitoring unit 30 starts to move from a first position to a second position along the lengthwise direction of the wire net 20 and then returns to the first direction and moves repeatedly in this fashion so as to accomplish the persistent monitoring of the status of the wire net 20 in the first rotation direction until the rotation along the first rotation direction is terminated. In the whole process, the monitoring unit 30 on the right side is at rest. Likewise, when the first rotation direction is switched to the second rotation direction, this rotation direction is a backward rotation for the monitoring unit 30 on the left side, and is a forward rotation for the monitoring unit 30 on the right side. The monitoring unit 30 on the left side starts to return to its initial position, and the monitoring unit 30 on the right side starts to monitor the status of the wire net 20 in the second rotation direction along a preset activity track until the rotation along the second rotation direction is terminated. The first position is an initial position where the monitor 31 starts to monitor, and the second position is an end position where the monitor 31 completes the monitoring. The first position and the second position can be any position on the length of the wire net 20. In this embodiment, the first position is a point within the length of the wire net 20 at one end of the workpiece 10, that is, its initial point; the second position is a point within the length of the wire net 20 at the other end of the workpiece 10, that is, its end point.

The monitor 31 can be a radar sensor or a laser sensor. Preferably, the monitor 31 is a radar sensor, which can persistently and uninterruptedly transmit probe signals everywhere in each area of the wire net 20 and can transmit the probe signals accurately and clearly at the position of the wire net 20 especially when the wafering is performed in a dark slicing chamber. Also, the radar sensor will not be affected by the mist. Driven by the power unit 50, it can reciprocate along the lengthwise direction of the wire net 20 to monitor the cutting wires in each area of the wire net 20, thereby ensuring the sustainability and consistency of the wire net status monitoring.

The monitor 31 moves from the first position to the second position along the lengthwise direction of the wire net 20, that is, from one end to the other end of the wire net 20 used for cutting the workpiece 10. The monitor 31 can continuously transmit signals toward the cutting wires and capture returned signals to identify the position of the cutting wires in each area such that within the length of entire wire net 20 the cutting wires in each area can be scanned and detected by the monitor 31. The monitor 31 itself has a signal capturing module and a digital conversion module, which can convert the captured signals into digital signals that can be recognized by the controller 60. After the monitor 31 transmits the digital signals to the controller 60, the controller 60 uses moving average, Gaussian algorithm and median filtering in order, to denoise the digital signals to obtain a height value of each cutting wire in the wire net 20.

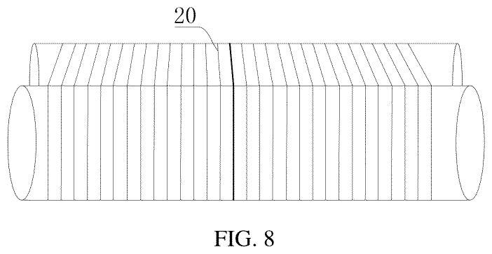

As shown in FIG. 8, along the lengthwise direction of the workpiece 10, the wire net 20 is divided into a plurality of equally-divided areas. Each area is taken as a unit. The monitor 31 detects the position of the cutting wires in each area to obtain the state of the position of the cutting wires. After the obtained position data of the cutting wires in each area are computed using preset formulas, a curvature value and a jump value of the cutting wires corresponding to each area are obtained and corresponding curvature curve and jump curve are formed. The monitor 31 can also monitor the height position of the wire net 20 after an amount of cutting steps reaches a preset threshold, so as to obtain a distribution of measured curvature curves to compare that with a standard curvature value to determine whether the workpiece 10 has been cut across. Once an abnormality occurs, the controller 60 will notify the wafering machine to give an alarm, and meanwhile it will also be clearly shown on a wire net area distribution chart on the display 70. In such a way, a curvature curve chart, a jump curvature chart and a cut-across curve chart can be perceived intuitively so as to determine which area has a problem, and then manual intervention or automatic parameter adjustment can be done directly based on prompts on each area. From the display 70, it can be directly judged whether the wire net 20 is in a normal state or not, that is, whether there are abnormal conditions such as jump and merge occurred on the wires. There is no need to wait for breakage occurred on the wire net 20, and a shutdown is encountered under this circumstance. It leads to enhanced substantial result and a coverage of whole process. It also realizes a judgment on cut-across in time. In this way, it can avoid a risk of false judgment or missing judgment caused by monitoring the wire net by means of camera shooting in existing arts. Also, it will not be affected by the intensity of light. It has not only enhanced substantial result but also high accuracy. The status of the wire net 20 can be monitored in real time.

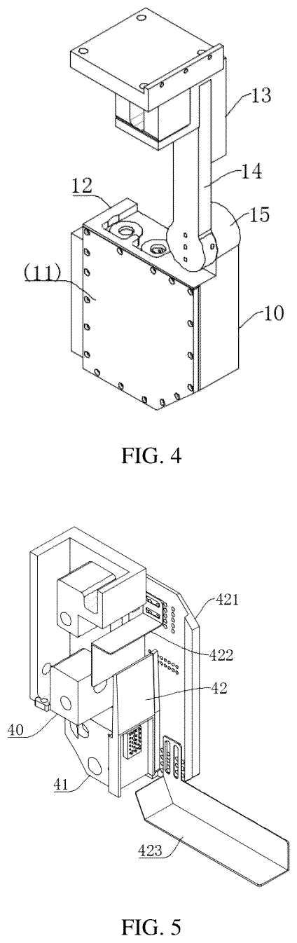

As shown in FIG. 4, the monitoring unit 30 also includes a housing 32 for protecting the monitor 31 and a position adjusting rod 33 connecting to the housing 32 for adjusting the direction of the housing such that the monitor is tilted to transmit signals toward a face of the wire net in contact with the workpiece. The aperture of the monitor 31 faces a side of the wire net 20 close to the workpiece 20 and is inclined downward. Not only the area being detected is large and the accuracy is high, but also it is easier to adjust and mount the monitoring unit 30. For an angle at which the monitor 31 is inclined downward, the inclined angle α can be, but is not limited to, an acute angle. The side of the housing 32 the aperture of the monitor 31 faces is configured as a vertical transparent face for ease of signal detection and propagation and being cleaned up. Other walls of the housing 32 can also be configured as transparent or opaque surfaces. The housing 32 is a closed structure, which not only can be dust-proof and water-proof, but also can prevent cleaning fluid from being accumulated in it. The housing 32 can be made of high-temperature resistant, moisture-proof and antistatic materials.

A lower end of the position adjusting rod 33 is connected to a lug boss on the top of the housing 32. One end of the position adjusting rod 33 connecting to the lug boss is configured as an arc surface structure, and the other end thereof is connected to a connecting block 52. The position adjusting rod 33 is hinged with the lug boss and abuts against the top of the housing 32. A connection point between the position adjusting rod 33 and the lug boss is taken as the center of a circle to rotate the housing 32 along the arc surface of the position adjusting rod 33 so as to adjust the position of the housing 32 to make the aperture of the monitor 31 inclined toward a side of the wire net 20.

As shown in FIGS. 1 and 5, the cleaning unit 40 is also provided at a position directly opposite the monitoring unit 30. The cleaning unit 40 is arranged at an end of the slicing chamber and includes a cleaning member 41 and an enclosing unit 42 that is placed around a cleaning end face of the cleaning member 41. The enclosing unit 42 includes a stand panel 421, an L-shaped folded panel 422 placed above the cleaning member 41, and a collecting panel 423 located obliquely below the cleaning member 41 and below the monitoring unit 30. The stand panel 421, the folded panel 422, the cleaning end face of the cleaning member 41 and the collecting panel 423 together form an accommodation area for accommodating an end surface corresponding to the aperture of the monitor 31 in the housing 32 to clean the end surface. Each monitor 31 corresponds to one cleaning unit 40, and the cleaning member 41 may clean in the accommodation area to clean the housing 32 when the monitor 31 returns to the first position.

The cleaning unit 40 and the monitoring unit 30 are set independently. The cleaning unit 40 may do a pressure test when the monitor 31 is working. In this way, when the monitor 31 returns to the first position, there is enough gas and liquid to clean silicon mud and cutting fluid on the transparent end surface of the housing 32. This can also reduce the overall weight such that an arrangement of gas delivery pipes and liquid delivery pipes can be simplified, and cooperation and operability of the overall structure are improved. In addition, this structure can reduce the area required by the monitoring unit 30, and thus a movable structure correspondingly designed for carrying the monitoring unit 30 can be simplified. In this way, the area required by the movement of the whole monitoring unit 30 is reduced, and space utilization of the slicing chamber is improved. In addition, there will be a great amount of silicon mud and cutting fluid during the wafering. If the cleaning unit 40 is integrated with the monitoring unit 30, it may increase the risk of congestion of circuit conduction and electric accessories. Therefore, the cleaning unit 40 has to be separated from the monitoring unit 30. When the cleaning unit 40 is safely arranged at an end of the slicing chamber far away from the wire net 60, it can also prevent the silicon mud from falling onto the wire net 60 during the cleaning.

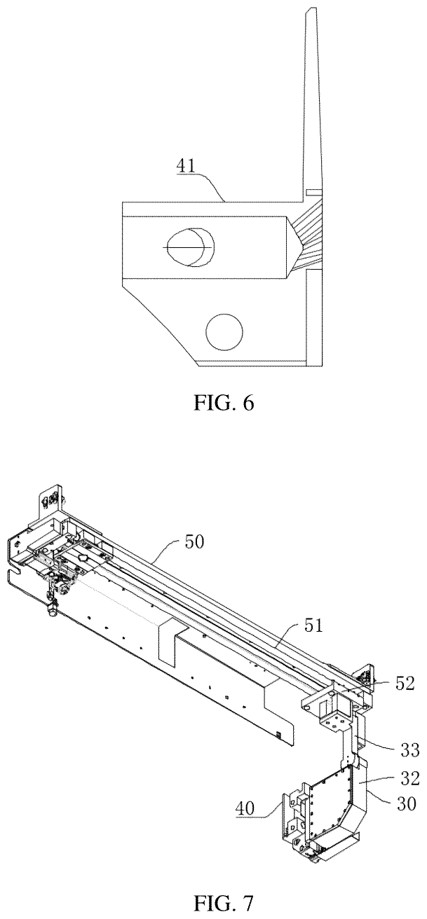

As shown in FIG. 6, the cleaning member 41 is provided with an inner cavity for accommodating a mixture of water and liquid and a plurality of spray holes communicating with the inner cavity. The inner cavity is connected to a gas pipe and a liquid pipe. After a gas from the gas pipe and a liquid from the liquid pipe are mixed in the inner cavity to form a gas-liquid fluid, the gas-liquid fluid flows out from the spray holes to spray and clean the transparent end surface of the housing 32 corresponding to the aperture of the monitor 31, thereby ensuring the cleaning of the transparent end surface of the housing 32. A side of the inner cavity close to the spray holes is an arc surface structure such that the length of each spray hole is not equal. The purpose of this design is to increase the jet rate of the spray holes at the center. In addition, flow channels of upper and lower parts of the spray holes located with respect to a central spray hole are arranged obliquely toward the housing 32. Preferably, the flow channels of the spray holes are all inclined so as to increase the anisotropy of the flow channels, increase the coverage of water sprayed from the spray holes, and further increase the flow rate of the sprayed liquid and improve the cleaning efficiency.

As shown in FIG. 7, the monitoring unit 30 is suspended on the power unit 50 arranged along the lengthwise direction of the slicing chamber, that is, the lengthwise direction of the wire net 20. The power unit 50 is provided with a long track 51 and the connecting block 52 matching the long track 51. The top of the connecting block 52 is connected to the long track 51. The long track 51 can be a transfer track such as a slide rail, or a chain, or a belt, and the connecting block 52 is a sliding member adapted thereto. That is, a set of monitoring units 30 and power units 50 are provided along the widthwise direction of the wire net 60, and the power unit 50 is arranged on the top of the slicing chamber. The connecting block 52 drives the monitor 32 to move on the long track 51.

An intelligent monitoring method realized by adopting the afore-described intelligent monitoring system for wire net wafering includes the following steps:

The control monitor 31 is controlled to capture position data of all cutting wires in each area of the wire net 20.

Specifically, the wire net 20 is divided into a plurality of equally-divided areas along the lengthwise direction of the workpiece 10, as shown in FIG. 8. Each area is taken as a unit. The monitor 31 detects the position of the cutting wires in each area.

The aperture of the control monitor 31 is controlled to be in a same direction as the rotation direction of the wire net 20 rotates, and when the controllers placed at both sides of the workpiece 10 are switched alternately between the first rotation direction and the second rotation direction of the wire net 20, the controllers 31 perform the monitoring of the wire net 20 in the first rotation direction and the wire net 20 in the second rotation direction alternately.

The monitor 31 is controlled to move from the first position at an end of the workpiece 10 to the second position at the other end of the workpiece 10 along the lengthwise direction of the wire net 20. The monitor 31 continuously transmits signals toward each cutting wire in each area and captures returned signals to identify the position of the cutting wires in each area. Meanwhile, the monitor 31 converts the captured signals into digital signals by itself and then transmits them to the controller 60.

After the controller 60 receives the digital signals transmitted by the monitor 31, the controller 60 uses moving average, Gaussian algorithm and median filtering in order, to denoise the converted digital signals to obtain a height value of each cutting wire in each area of the wire net 20. Therefore, the position of a lowest point on an arc surface of each cutting wire in all areas can be obtained, and thus the height value of each cutting wire in each area can also be obtained.

Based on the obtained height value of each cutting wire in each area, an averaged height of all the rigid wires in the area with respect to a contact surface of the workpiece 10 can be calculated, that is, the height of the wire net 20 in the area with respect to the contact surface of the workpiece 10.

Based on the obtained height position of each cutting wire in each area and the height position of the wire net in the area with respect to the contact surface of the workpiece, a vertical distance of each cutting wire in the area with respect to the wire net and the contact surface of the workpiece in the area is obtained, that is, a curvature value and a jump value corresponding to each cutting wire in the area.

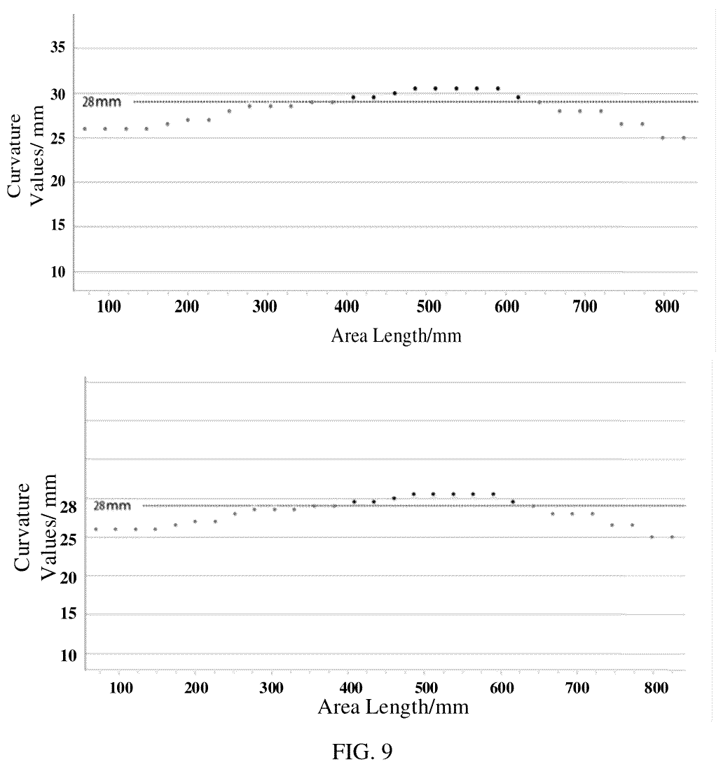

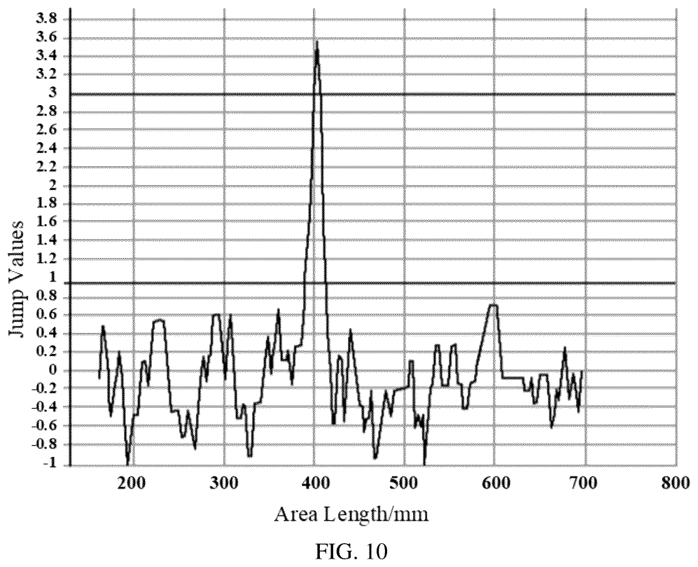

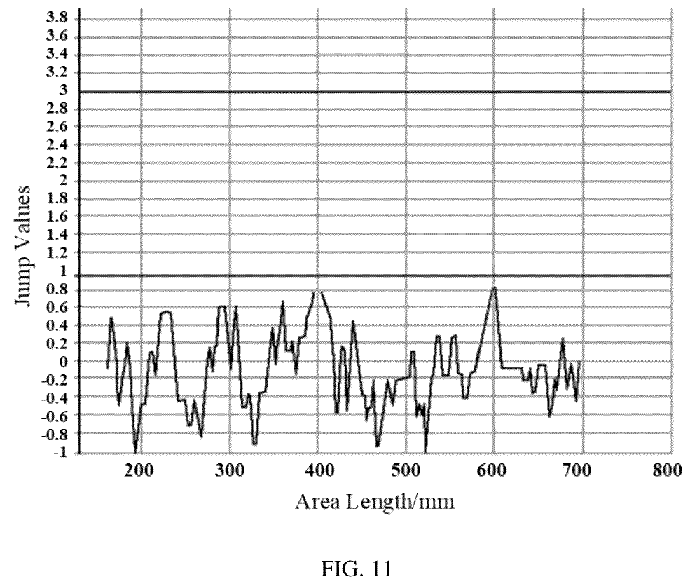

Based on the curvature values and the jump values of all the cutting wires in each area during the cutting process, an independent curvature curve (as shown in FIG. 9) and a jump curve (as shown in FIGS. 10 and 11) corresponding to each area can be formed.

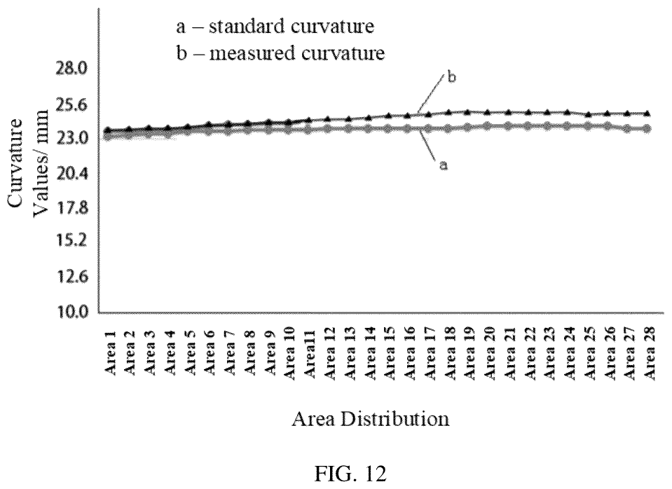

Based on the curvature value of each cutting wire in each area obtained when an amount of cutting steps reaches a preset threshold of the amount of the cutting steps, an overall curvature curve of all areas can be formed (as shown in FIG. 12).

Based on the independent curvature curve and jump curve corresponding to each area as well as the overall curvature curve of all areas, it is possible to identify which area is abnormal, and then manual intervention or automatic parameter adjustment can be done directly.

During the cutting process, based on the height position of each cutting wire in each area obtained by the monitor 31, the controller 60 can calculate the averaged height of all the rigid wires in the area with respect to the contact surface of the workpiece 10, that is, the height of the wire net 20 with respect to the contact surface of the workpiece 10. Also, the controller 60 processes the data such that after the obtained position data of the cutting wires in each area are processed using preset formulas, the curvature values and the jump values of the cutting wires corresponding to each area are obtained so as to form the independent curvature curve and jump curve corresponding to the area. Because the curvature curve and jump curve are mapped only to the curvature values and the jump values of all the cutting wires corresponding to a certain area along its lengthwise direction, it is called an independent curvature curve and jump curve. Which area has a problem can be determined by comparing the curvature curve chart and the jump curve chart with a standard curvature value and a jump threshold. Based on prompts on the area in FIG. 9, manual intervention can be directly performed on the abnormal cutting wire in the slicing chamber.

When the amount of cutting steps reaches the present threshold of the amount of cutting steps, the monitor 31 can also monitor the height position of the wire net 20 to a distribution of measured curvature curves to compare that with a standard curvature value to determine whether the workpiece 10 has been cut across. Once an abnormality occurs, the controller 60 will notify the wafering machine to give an alarm, and meanwhile it will also be clearly shown on a wire net area distribution chart on the display 70. In such a way, a curve chart corresponding to all the curvature values in all the areas can be perceived intuitively. Because it records the curvature values corresponding to all areas in the entire wire net, it is called an overall curvature curve chart, that is, a cut-across curve chart, so as to judge and identify which area has a problem. Based on prompts on the area, an automatic parameter adjustment can be directly performed.

Specifically, during the cutting process, as the amount of cutting steps continuously increases, the curvature values of all the cutting wires in each area are obtained based on the height differences in the vertical direction between values of the lowest points of detected cutting wires and the contact surface of the workpiece. A curve chart of a distribution of curvature values of all the cutting wires in each area is provided, as shown in FIG. 9. It can be seen from this figure a distribution of the curvature values corresponding to the cutting wires in this area. Assuming that a standard threshold is 3, the values above the standard line are abnormal values, and the values below the standard line are qualified values, it indicates that the curvature values in this area are inconsistent with each other. Correspondingly, in the area distribution shown in FIG. 8, the color of a wire in the corresponding area will be changed to red for warning. When the curvature value of a cutting wire is large, it indicates that the cutting wire is tight. It has to adjust the parameters to optimize the process parameters, otherwise it is easy for the wire net to have a broken wire. The controller 60 will notify the system to adjust the cutting process according to the results from the processing. The rotation speed of the cutting wires remains unchanged and the speed of feeding the workpiece 10 is reduced such that the curvature value is lowered. When the curvature value is lower than a minimum standard threshold, the controller 60 will automatically notify the system to increase the speed of feeding the workpiece 10 or adjust the cutting speed to rise the curvature value to meet standard requirements.

Based on the height position of each cutting wire in each area and the height position of the wire net 20 with respect to the contact surface of the workpiece 10, the controller 60 can automatically calculate a vertical height difference between each cutting wire, and the wire net 20 and the contact surface of the workpiece 10, thereby obtaining a jump value for each cutting wire. Based on the jump value of each cutting wire and the lengthwise direction for each area in the wire net 20, a jump curve chart is obtained, where the length of each area is taken as an X-axis and the jump value of the cutting wire is taken as a Y-axis. The calculated jump values of the cutting wires in all the areas are connected together to form a jump curve, which is directly shown on the display 70 of the wafering machine.

As shown in FIG. 10, it is a jump curve chart for a certain area in the wire net 20. As can be seen from this figure, the jump curves of all the cutting wires in this area are always continuous. When the jump value of a cutting wire at any position exceeds a preset standard threshold, it can be determined that the wire net at that position encounters a jump abnormality. During the wafering process, if there is no jump abnormality, the jump curve is continuous and stable. Once a cutting wire encounters the jump abnormality, there will have a certain height difference in the vertical direction between the jumping cutting wire and the contact surface of the wire net 20 and the workpiece 10. This height difference is the jump value. The change of the jump value will be directly reflected on the jump curve on the display. It is obvious that the jumping cutting wire will have a larger protrusion. The larger the jump degree, the more obvious the protrusion on the curve.

In a merge abnormality, when the jump value at a certain position in any area exceeds a first standard threshold and is smaller than a second standard threshold, the controller will control the wafering machine to alarm and shut down based on the judgment. It only needs to move the abnormal cutting wire back to its original groove, and then the wafering process can be continued.

When the jump value at a certain position in any area exceeds the second standard threshold, it indicates that the jumping cutting wire has been seriously deformed and cannot be used to cut the workpiece 10. If the jumping cutting wire encountering a serious deformation is still used to cut the workpiece 10, it will result in wire breakage and also produces more wafers with poor quality. Also, the controller controls the wafering machine to alarm and shut down based on the judgment. The jumping cutting wire and two or three cutting wires adjacent to it are cut off. The cut-off cut cutting wires are reconnected, and the reconnected cutting wires are moved to their corresponding grooves to continue the wafering process.

Assuming that the first standard threshold is 1 and the second standard threshold is 3, it can be seen from FIG. 10 that the jump values at a position between 400-500 mm and close to 400 mm are obviously greater than the second standard threshold 3, and the jump values at 600 mm is greater than the standard threshold 1 and less than the second standard threshold 3. Then, it can be directly determined that the cutting wires at these two positions encounter the jump abnormality. Correspondingly, in the area distribution shown in FIG. 8, the color of the wires in corresponding areas will be changed to red for warning. After the system is shut down, a personnel can accurately and quickly find corresponding areas on the wire net 20 in the slicing chamber based on the automatically-indicated position in FIG. 8. For the jumping cutting wire with a jump value greater than the second standard threshold 3, the jumping cutting wire and two or three cutting wires adjacent to it are cut off, and the cut-off cut cutting wires are reconnected, and the reconnected cutting wires are moved to their corresponding grooves. For the jumping cutting wire with a jump value greater than the first standard threshold 1 and less than the second standard threshold 3, the jumping cutting wire is moved back into its original groove, and the wafering is continued.

As shown in FIG. 11, it is a jump curve chart for a certain area in the wire net 20. When there is a breakpoint at a certain position, it means that the cutting wire at this position has not been detected by the monitor 31. In normal situation, the wire net 20 is evenly distributed in the grooves on a sheave, and a curve connecting all the jump values is continuous and fluctuates up and down within a certain range. If the cutting wire merges into other adjacent groove, there will be no cutting wire in the empty groove such that the monitor 31 cannot detect the cutting wire corresponding to the empty groove, that is, the monitor 31 cannot detect the position signal of the merged cutting wire. As a result, there has no data for the jump value of the merged cutting wire, and thus a breakpoint is shown on the jump curve, that is, it means a merge abnormality is encountered. At this time, the monitor 31 notifies the alarm system of the wafering machine via the controller to give an alarm and shut down the machine. Manual intervention is started, and the cutting wire encountering the merge abnormality is moved back to its original groove.

It can be seen from FIG. 11 that all the jump values are less than the first standard threshold 1, but for the jump values, a breakpoint occurs at 400 mm. It indicates that the monitor 31 cannot detect the position signal of the cutting wire at this position. As a result, there has no data for the jump value, a breakpoint is shown on the jump curve, and this means the cutting wire at this position encounters the merge abnormality. Correspondingly, in the area distribution shown in FIG. 8, the color of the wire in a corresponding area will be changed to red for warning. After the system is shut down, a personnel can directly find a corresponding area on the wire net 20 in the slicing chamber based on the automatically-indicated position in FIG. 8 and moves the cutting wire encountering the merge abnormality back into its original groove, and the wafering is continued.

As shown in FIG. 12, when a total amount of cutting steps reaches a preset threshold, the testing results of the curvature values of the cutting wires in each area by the monitor 31 are shown together on a curve chart to compare with a standard curvature value again to obtain a comparison result. The horizontal axis of this chart indicates the areas evenly distributed along the lengthwise direction of the workpiece 10, and the vertical axis of this chart indicates the curvature values. The standard curvature value is indicated by curve a, indicating when the workpiece 10 is cut across. The measured curvature values obtained by the monitor 31 are indicated by curve b. It can be seen from this figure that the measured curvature values from the area 6 to the area 28 are all greater than the standard curvature value. This means that the workpiece 10 has not been cut across from the area 6 to the area 28. After the controller 60 has made a judgment, the system is immediately notified to execute an extra cutting process. Correspondingly, the display 70 is notified to directly change the color of wires in corresponding areas from the area 6 to the area 28 in FIG. 8 to red for warning. It means that the workpiece in these areas has not been cut across. If workpiece 10 is not cut across, an extra cutting process is executed until the workpiece 10 has been cut across.

The intelligent monitoring system and method for wire net wafering, designed in accordance with the present disclosure, can automatically monitor the status of curvature of the wire net, automatically judge whether the status of the wire net is abnormal, minimize manual intervention, automatically process based on the judgment, and effectively notify the wafering machine in time, if a problem is encountered, to perform parameter adjustment or transfer to manual intervention.

When the curvature values or jump values are abnormal, it can be directly judged from the display whether the wire net is in a normal state or not, that is, whether there are abnormal conditions such as inconsistent curvature, jump and merge. These problems can be aware of without a need to wait for breakage occurred on the wire net and a shutdown. This control method is effective and has a coverage of whole process. In addition, it can also judge in time whether the workpiece is cut across so as to avoid a risk of false judgment or missing judgment caused by monitoring the wire net by means of camera shooting in existing arts. Also, it will not be affected by the intensity of light. It has not only enhanced substantial result but also high accuracy. The status of the wire net can be monitored in real time.

The embodiments of the present disclosure have been described in detail above, and the above descriptions are only preferred embodiments of the present application and are not used to limit the scope of the present disclosure. Any equivalent modification, improvement, etc. made within the scope of the present disclosure shall be included in the scope of this patent application.

What is claimed is:

1. An intelligent monitoring system for wire net wafering, comprising:
a monitoring unit, equipped with a monitor for capturing position data of cutting wires in a wire net; and
a control unit, provided with a controller for receiving the data captured by the monitor, processing the data and notifying a wafering machine based on results of the processing to perform optimization and adjustment.

2. The system of claim 1, wherein an aperture of the monitor is arranged in a same direction as a rotation direction of the wire net;
the monitor moves from a first position to a second position along a lengthwise direction of the wire net, and continuously transmits signals toward the cutting wires and captures returned signals to identify the position of the cutting wires;
the captured signals are converted into digital signals, which are then transmitted to the controller.

3. The system of claim 2, wherein the controller is placed at each of two sides of a workpiece, and the controllers placed at both sides of the workpiece are disposed opposite to each other;
when the controllers placed at both sides of the workpiece are switched alternately between a first rotation direction and a second rotation direction of the wire net, the controllers perform the monitoring of the wire net in the first rotation direction and the wire net in the second rotation direction alternately.

4. The system of claim 3, wherein the monitoring unit further comprises:
a housing, for protecting the monitor; and
a position adjusting rod, connecting to the housing for adjusting a direction of the housing such that the monitor is tilted to transmit signals toward a face of the wire net in contact with the workpiece.

5. The system of claim 4, further comprising a cleaning unit, provided at a position directly facing the monitoring unit, wherein the cleaning unit comprises a cleaning member and an enclosing unit that is placed around the cleaning member, and the enclosing unit is provided with an accommodation area for accommodating an end surface corresponding to the aperture of the monitor in the housing;
wherein the cleaning member cleans in the accommodation area to clean the housing when the monitor moves to the first position.

6. The system of claim 1, further comprising a power unit, which comprises a long track and a connecting block arranged along a lengthwise direction of the wire net, wherein the monitoring unit is connected to the connecting block, and the connecting block drives the monitoring unit to move on the long track.

7. The system of claim 1, further comprising a display unit, provided with a display, wherein the controller displays the results of the processing on the display in a form of curves.

8. An intelligent monitoring method for wire net wafering, comprising the steps of:
controlling a monitor to capture position data of cutting wires in a wire net;
receiving the data captured by the monitor, processing the data and notifying a wafering machine based on results of the processing to perform optimization and adjustment.

9. The method of claim 8, wherein the controlling the monitor to capture the position data of the cutting wires in the wire net comprises:
controlling an aperture of the monitor to be arranged in a same direction as a rotation direction of the wire net;
controlling the monitor to move from a first position to a second position along a lengthwise direction of the wire net, and continuously transmit signals toward the cutting wires and capture returned signals to identify the position of the cutting wires;
converting the captured signals into digital signals, which are then transmitted to the controller.

10. The method of claim 8, wherein the receiving the data captured by the monitor, processing the data and notifying the wafering machine based on results of the processing to perform optimization and adjustment comprises:
denoising, by the controller, the converted digital signals by using moving average, Gaussian algorithm and median filtering, to obtain height position of each cutting wire in each area of the wire net, and based on the obtained height position of each cutting wire in each area and the height position of a contact surface of a workpiece and the wire net in an area, obtaining a vertical distance between each cutting wire in the area and the contact surface of the workpiece and the wire net in the area, which is a curvature value and a jump value corresponding to each cutting wire in the area;
based on the curvature values and the jump values of all the cutting wires in each area during a cutting process, forming an independent curvature curve and jump curve corresponding to each area;
based on the curvature value of each cutting wire in each area obtained when an amount of cutting steps reaches a preset threshold, forming an overall curvature curve of all areas;
based on the independent curvature curve and jump curve corresponding to each area as well as the overall curvature curve of all areas, identifying which area is abnormal, and performing a parameter adjustment.

11. An intelligent monitoring system for wire net wafering, comprising:
a monitoring unit, equipped with a monitor for capturing position data of cutting wires in a wire net;
a power unit, for driving the monitor to move from a first position to a second position along a lengthwise direction of the wire net such that the monitor continuously transmits signals toward the cutting wires and captures returned signals;
a control unit, provided with a controller for receiving the data captured by the monitor, processing the data and notifying a wafering machine based on results of the processing to perform optimization and adjustment; and
a display unit, provided with a display, wherein the controller displays the results of the processing on the display in a form of curves.

12. The system of claim 11, wherein an aperture of the monitor is arranged in a same direction as a rotation direction of the wire net.

13. The system of claim 11, wherein the captured signals are converted into digital signals, which are then transmitted to the controller.

14. The system of claim 11, wherein the controller is placed at each of two sides of a workpiece, and the controllers placed at both sides of the workpiece are disposed opposite to each other.

15. The system of claim 14, wherein when the controllers placed at both sides of the workpiece are switched alternately between a first rotation direction and a second rotation direction of the wire net, the controllers perform the monitoring of the wire net in the first rotation direction and the wire net in the second rotation direction alternately.

16. The system of claim 15, wherein the monitoring unit further comprises:
a housing, for protecting the monitor; and
a position adjusting rod, connecting to the housing for adjusting a direction of the housing such that the monitor is tilted to transmit signals toward a face of the wire net in contact with the workpiece.

17. The system of claim 16, further comprising a cleaning unit, provided at a position directly facing the monitoring unit, wherein the cleaning unit comprises a cleaning member and an enclosing unit that is placed around the cleaning member, and the enclosing unit is provided with an accommodation area for accommodating an end surface corresponding to the aperture of the monitor in the housing;
wherein the cleaning member cleans in the accommodation area to clean the housing when the monitor moves to the first position.

18. The system of claim 11, wherein the power unit comprises a long track and a connecting block arranged along a lengthwise direction of the wire net, wherein the monitoring unit is connected to the connecting block, and the connecting block drives the monitoring unit to move on the long track.
